(19) United States
(12) Patent Application Publication
(10) Pub. No.: US 2011/0038030 A1
(43) Pub. Date: Feb. 17, 2011

(54) ELECTROPHORETIC DISPLAY WINDOW

(75) Inventors: Sander Jurgen Roosendaal, Brno (CZ); Mark Thomas Johnson, Veldhoven (NL); Tatiana Aleksandrovna Lashina, Eindhoven (NL); Evert Jan Van Loenen, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/989,454

(22) PCT Filed: Apr. 23, 2009
(86) PCT No.: PCT/IB2009/051670

§ 371 Date: Oct. 25, 2010

(30) Foreign Application Priority Data
Apr. 30, 2008 (EP) 08103797.0

(51) Int. Cl. G02F 1/167

(52) U.S. Cl. 359/296

(57) ABSTRACT

A window (110, 210, 310, 410, 510) including blind elements (120, 210, 320, 330, 340, 350, 360, 370, 380, 385, 390, 420, 430, 490) embedded within the window (110, 210, 310, 410, 510) and/or associated with the window (110, 210, 310, 410, 510). The blind elements (120, 210, 320, 330, 340, 350, 360, 370, 380, 385, 390, 420, 430, 490) may be embedded at least partially in the window (110, 210, 310, 410, 510). The blind elements (120, 210, 320, 330, 340, 350, 360, 370, 380, 385, 390, 420, 430, 490) may be positioned substantially perpendicular to a viewing surface of the window (110, 210, 310, 410, 510). Each of the blind elements (120, 210, 320, 330, 340, 350, 360, 370, 380, 385, 390, 420, 430, 490) includes a display surface (150) that may include display elements (750, 760) positioned to be viewable through the window (110, 210, 310, 410, 510) such that if the window (110, 210, 310, 410, 510) is viewed from an angle offset from a normal viewing angle, the surface on each of the blind elements (750, 760) are together configured to provide a display image. A further layer (316, 318) may be associated with the window (110, 210, 310, 410, 510) and the blind elements (120, 210, 320, 330, 340, 350, 360, 370, 380, 385, 390, 420, 430, 490) may be sandwiched between the further layer (316, 318) and the window (110, 210, 310, 410, 510).

### FIELD OF THE INVENTION

The present invention relates to electrophoretic display elements that are at least partially embedded in a window and that are positioned substantially perpendicular to the window.

### BACKGROUND OF THE INVENTION

An electrophoretic display element (EDE) modulates light through movement of charged particles in a liquid in response to an electric field. The charged particles may have a particular color, shade or be monochromatic, that, by moving the particles under the influence of the electric field, become visible and thereby provide the color, shade or monochromatic impression to that display element. Displays are made up by grouping these display elements to make up, for instance, picture elements (pixels) or groups of pixels of the display. EDEs may operate in one or more of a transmissive mode, wherein activation of the EDEs results in modulation of light passing through the EDEs, and a reflective mode, wherein activation of the EDEs selectively reflects light. Individual EDEs may be constructed to operate in one of either a reflective or transmissive mode. EDE's may be layered to provide for a plurality of colors per visible pixel or for both a reflective and transmissive function per visible pixel.

It is known to place EDEs over windows to control a transmissive quality of the window. German Patent Application No. DE3737320A1, which is incorporated by reference herein, discloses thin-sheeted liquid crystal display (LCD) elements arranged as horizontal window blind elements that cover sub-regions of a window. The LCD elements are arranged parallel and directly over a surface of the window. The LCD elements can be stimulated such that, depending on a degree of stimulation, the elements can be transparent or opaque over the entire surface, or an array of LCD drivers may be provided wherein each LCD element may be selectively activated.

U.S. Pat. No. 7,182,467, which is incorporated by reference herein, discloses a use of reflective microstructures either completely embedded in the glass or positioned on a surface of the glass and that are positioned perpendicular to a surface of the glass. A projector is positioned to project an image at an angle incident to the surface of the glass such that the projected image is reflected by the reflective microstructures and thereby is visible at a given angle of viewing. When the window is viewed straight-on, the projected image is not visible and objects behind the glass may be visible. However, the use of a projector is not ideal. It is difficult to get the light evenly distributed over the microstructures. In addition, the reflective microstructures positioned further away from the projector will be darker than the reflective microstructures positioned closer to the projector resulting in an undesirable varying of brightness over the window. Furthermore, the projector has to be installed and optimized with the window which greatly complicates each installation.

U.S. Patent Publication No. 2002/0063809, which is incorporated by reference herein, discloses use of LCDs distributed over a window in a planar sheet, such as a planar plastic sheet, to control opacity of the window. U.S. Patent Publication No. 2006/0038772, which is incorporated by reference herein, discloses use of capsule-shaped EDEs that are aligned on a surface of a window. The EDEs contain two-types of charged particles, with each particle exhibiting different electrostatic properties such that when viewed, the EDEs can selectively appear white, black or transparent.

A problem exists in the prior solutions in that none of the prior solutions provides an eye-catching display window that is simple to set-up and that enables a display of information (e.g., advertising) when viewed from an approaching angle that does not obstruct a view through the window when viewed at a normal viewing angle (e.g., essentially at an angle perpendicular to a surface of the display window).

### SUMMARY OF THE INVENTION

It is an object of the present system to overcome these and other disadvantages in the prior art.

An article of manufacture, preferably a window, is provided including blind elements associated with the window. The blind elements may be positioned substantially perpendicular to a viewing surface of the display window and may be at least partially embedded within the window. Each of the blind elements includes a display surface that may include display elements positioned to be viewable through the display window such that if the display window is viewed from an angle offset from a normal viewing angle, the surface on each of the blind elements are together configured to provide a display image.

The display elements may be formed from a plurality of electrophoretic cells that provide the display image. The electrophoretic cells may provide the display image colored in one of a red, green and blue color space or a cyan, magenta and yellow color space. The electrophoretic cells may include light scattering charged particles and the light scattering charged particles may be presented as a portion of the display image. The display surfaces may each include a reflective surface deposed around the display elements. In this embodiment, the reflective surfaces provide a reflected image as a portion of the display image.

The display surfaces may be covered by electronic ink material that provides the display image. In one embodiment, the display surfaces may provide two or more of an emissive display state, a transparent state, a white state and a reflective state. In one embodiment, each of the blind elements includes two display surfaces. Each of the display surfaces of the blind elements may be positioned on oppositely opposing sides of each of the blind elements and may produce a related or independent display image. The article of manufacture may comprise a matrix display driver circuit which produces each of the display images.

Such an article of manufacture may preferably be a shop window which can be looked through when viewed from a normal viewing angle. While the display image may be an advertising image which can be viewed through the shop window when the shop window is viewed from an angle offset from the normal viewing angle. It may also be any other window which may be used in a home environment.

Further a method is provided which provides an advertising image, the method comprising acts of:

providing a plurality of blind elements associated with a window, wherein each of the plurality of blind elements comprise a plurality of display elements positioned to be viewable through the window:

producing the advertising image by the plurality of display elements such that the advertising message is viewable from an angle offset from a normal viewing angle.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present invention. Further, the drawings are not drawn to scale and in some cases, dimensions are exaggerated to help illustrate operation in accordance with the present system.

### BRIEF DESCRIPTION OF THE DRAWINGS

It should be expressly understood that the drawings are included for illustrative purposes and do not represent the scope of the present system.

FIG. 1 shows an arrangement in accordance with embodiment of the present system;

FIG. 2 shows an arrangement in accordance with embodiment of the present system;

FIG. 3 shows a cross sectional view of a first element including embedded second element types and un-embedded third element types wherein the cross sectional view is taken substantially perpendicular to an outside surface of the first element in accordance with an embodiment of the present system;

FIG. 4 shows a view of a display window from a point of view substantially normal to the display window in accordance with an embodiment of the present system;

FIG. 5 shows a view of a window from a point of view substantially normal to the window in accordance with an embodiment of the present system;

FIG. 6 shows a view of a window from a point of view off-center from substantially normal to the window in accordance with an embodiment of the present system; and

FIG. 7 shows in-plane electrophoretic cells in accordance with an embodiment of the present system.

### DETAILED DESCRIPTION OF EMBODIMENTS

As utilized herein, the term “colored” and derivatives thereof are intended to include a monochromatic shade, such as white and black, as well as being within other portions of a colored space, such as a colored space defined by one or more of red, green and blue colored elements. In addition, the term should be understood to include a reflective surface, although in some cases, as made explicitly clear by the following description, one or more of these colored states will be described.

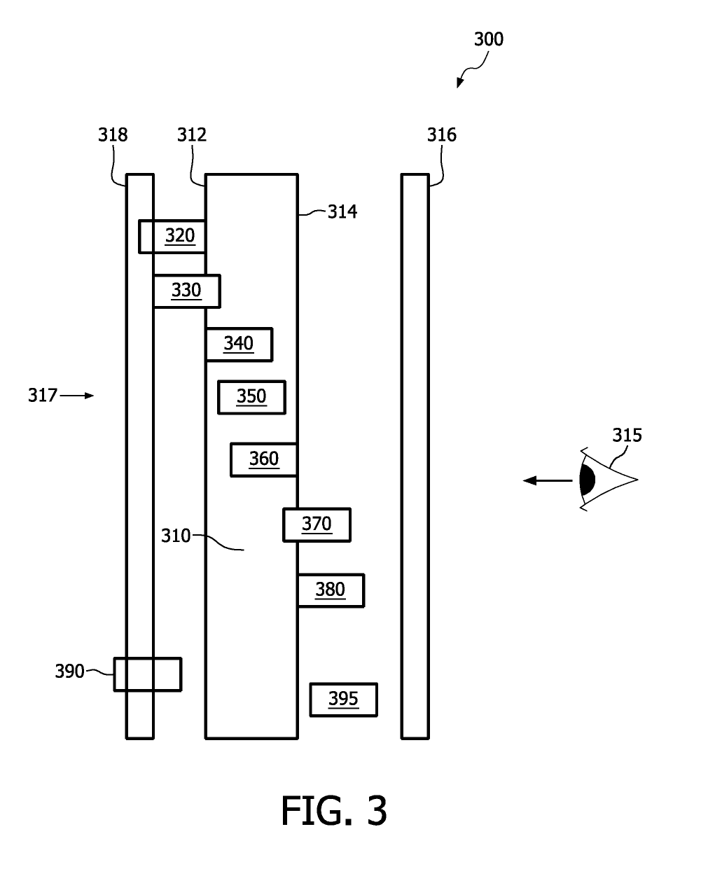

The terms “embedded”, “partially embedded” and formatives thereof as utilized herein refers to a relationship between elements wherein at least a portion of a first element that is embedded in a second element is at least partially contained within the second element. Accordingly, the embedded first element at least partially extends into the second element beyond an outside surface of the second element. For example, a first element that is embedded into a second element is at least partially contained within the second element. FIG. 3 shows a cross sectional view 300 of an element 310 (e.g., such as a window) including embedded second element types (elements 330, 340, 350, 360, 370) and un-embedded element types (elements 320, 380, 390, 395), wherein the cross sectional view 300 is taken substantially perpendicular to an outside surface (either of outside surfaces 312, 314) of the element 310. As shown, the element 330 (e.g., a blind element and/or an electrophoretic display element) is embedded within the element 310 as indicated since at least some portion of a sectional view of the element 330 is shown surrounded by the element 310 on at least three sides. Naturally an embedded first element may also be completely contained within the second element and still be considered embedded in terms of the present system as shown for an element 350 which is embedded in the element 310. Accordingly, unless specifically stated otherwise, any state of the first element (e.g., any one of elements 330, 340, 350, 360, 270 and positions there between) wherein the first element is at least partially positioned between a first outside surface (e.g., the outside surface 312) of the second element (e.g., the element 310) and a second (opposing) outside surface (e.g., the second outside surface 314) of the second element describes a state wherein the first element is embedded in the second element in accordance with the present system and is intended to be encompassed by the present system and claims that follow. Conversely, elements 320, 380, 390, 395 are not embedded in element 310.

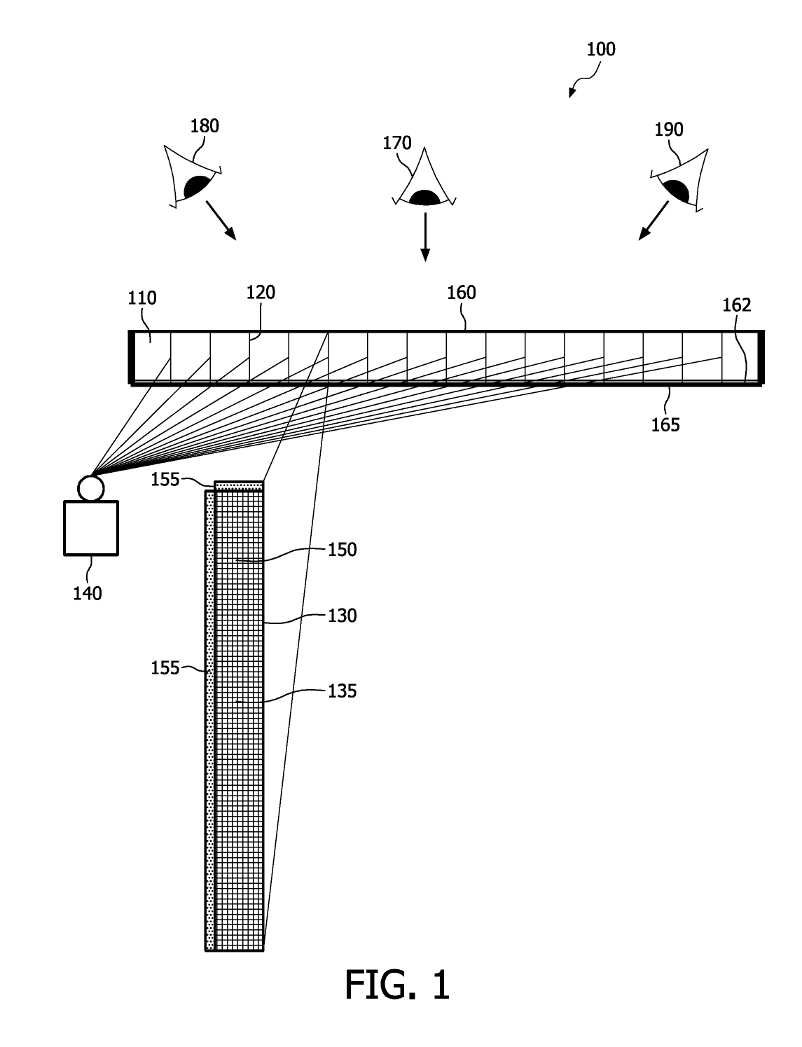

FIG. 1 shows an arrangement 100 in accordance with an embodiment of the present system including a plurality of blind elements 120 extending vertically and embedded in a window, such as a display window 110. As shown, the plurality of blind elements 120 are arranged substantially perpendicular to a display surface 160 of the display window 110. As may be readily appreciated, the blinds are substantially perpendicular so as to present as small a surface area of the blind elements, in this case edges of the blind elements 120, to a viewer of the display window 110 that is viewing the blind elements 120 from substantially a normal direction (e.g., substantially 90 degree viewing direction with reference to the viewing surface, such as the display surface 160 of the display window 110). Naturally, the blind elements 120 may be substantially perpendicular, such as +/−5 degrees of perpendicular and such as +/−10 degrees of perpendicular or an other angle more or less than substantially perpendicular, to vary images presented to an approaching viewer as discussed in detail below. However as may be appreciated, the less perpendicular the blind elements are with respect to a surface of the display window, the larger the surface area of the blind elements that is presented to a viewer viewing the display window from a position substantially normal to the display window.

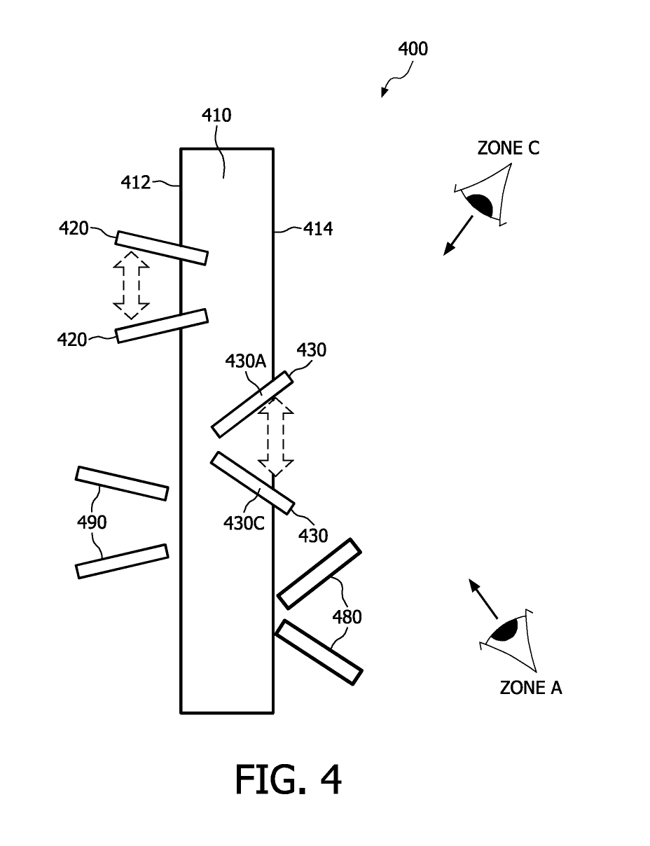

FIG. 4 shows a view 400 of a display window 410 providing a similar sectional view of the display window 410 as provided for the display window 110 shown in FIG. 1. As shown, elements 420, 430 are embedded in the display window 410. The elements 420 are substantially perpendicular, such as +/−10 degrees of perpendicular to a display surface 412 of the display window 410. As may be readily appreciated, an other angle less than the angle presented by the elements 420 is still considered substantially perpendicular in accordance with the present system as indicated by the dashed arrow positioned between the elements 420. In accordance with an embodiment of the present system, the elements 430 are embedded at an angle of substantially +/−45 degrees of perpendicular to a display surface 414 of the display window 410 which is about the outside limit of what is useful of an embedded element that it is desired is useable for viewing from both sides of the element 430 in accordance with the present system.

Blind 130 shows illustrative details of one of the plurality of blind elements 120. As illustratively shown, the blind 130 includes a matrix display consisting of rows and columns of individually addressable display elements 150. As such and as may be readily appreciated, the blind 130 includes row and column addressing and driving circuits 155 embedded along one or more edges of the blind 130. In another embodiment, the driver circuits 155 may be present in a window frame 115, with connections to row and column lines on the top and side of the blind elements 120. The size and number of display elements 150 may range from fewer large display elements (e.g., pixels) to more small display elements as suits a given application. In addition, spacing between display elements may be similarly adjusted as desired with an obvious result that larger pixels and/or spacing between pixels may be simpler to configure and control, but typically results in a courser display image. Details of illustrative display elements follows herein.

As should be clear from an examination of FIG. 1, when a viewer is viewing the display window from straight-on, such as substantially from a 90 degree angle with reference to the display surface 160 of the display window 110 such as shown by the point-of-view 170 (hereinafter referred to as normal), the blind elements 120 are virtually invisible since from this angle, only an edge of the blind elements 120 are visible.

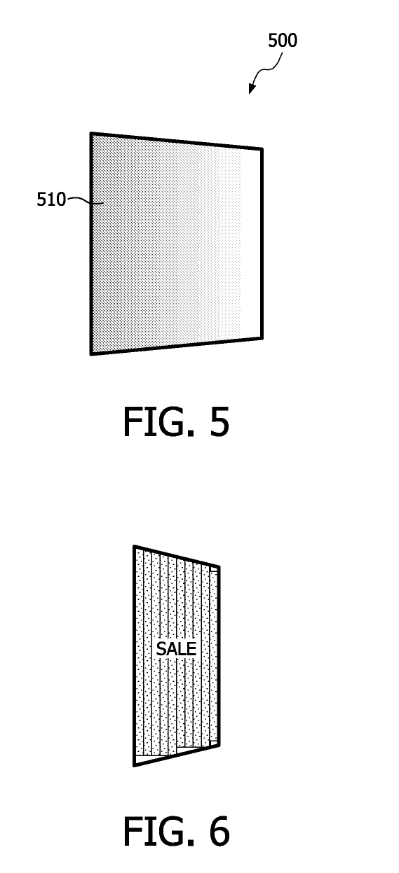

FIG. 5 shows a view 500 of a display window 510 that is similar as a view of the display window 110 when viewed from the point of view 170. As shown, embedded blind elements are imperceptible since from this point of view, substantially only edges of the blind elements are presented from this point of view. Returning to FIG. 1, naturally, as the viewer's incidence angle from normal increases, more of the blind surface 135 is visible. For example, more of the blind surface 135 is visible from points-of-view 180, 190 as compared to the point-of-view 170, enabling viewing of the display elements 150 from the points-of view 180, 190. In this way and in accordance with the present system, the display elements 150 of the blind elements 120 may be utilized together to create a display image, which is viewable from the points-of-view 180, 190, but which is substantially invisible from the point-of view 170. In this way, by viewing the blind elements 120 from an angle offset from a normal viewing angle, the blind elements 120 together may present a (single) visual impression made up by the individual pieces of the visual impressions provided by each of the (individual) blind elements 120.

For blind elements 120 with a width “w” spaced apart from each other at a distance “p”, an optimal viewing angle may be achieved (e.g., an angle wherein the blind elements form a substantially continuous image without an apparent spacing or overlap between the blind elements 120) from either of the points-of-view 180, 190, as given by a tan(p/w). For example, for a viewing angle of 70 degrees (with respect to the window normal) towards the point-of-view 180, a ratio of p/w=2.7 may be achieved for a given illustrative configuration of blinds, wherein for example, p=27 mm, w=10 mm or for p=27 cm, w=10 cm. This configuration of blinds, when viewed at 10 degrees, provides a window aperture of 93%. In other words, from a 10 degree viewing angle, the window is 93% unobstructed which provides for a very clear window. Naturally when viewed from an angle less than 10 degrees, the window will appear even clearer. As may be readily appreciated, the aperture is only a function of the ratio p/w, thus a very fine blind structure (e.g., a thin edge of the blind elements) may be used with is nearly invisible to the viewer at normal incidence. For viewing angles smaller than the optimal angle, a mixture between the display image produced by the display elements 150 and objects visible though the display window are visible. For viewing angles larger than the optimal angle, the blind elements 120 will apparently overlap.

As may be readily appreciated, the present system may be applicable to any arrangement where it is desired to provide an alternate image from an angled view, than an image provided when viewing from an angle substantially normal to a view of a primary image, such as may be provided from viewing in through a window. Accordingly, although the terms window, display window, formatives and other variations thereof are utilized herein, each of these terms should be understood to encompass any article of manufacture that is viewable through to provide an image from a direction substantially in front of the article of manufacture, such as an angle substantially normal to the article of manufacture, for which the present system may be readily applied to provide one or more alternate images viewable from an angle offset from normal to the article of manufacture as described herein.

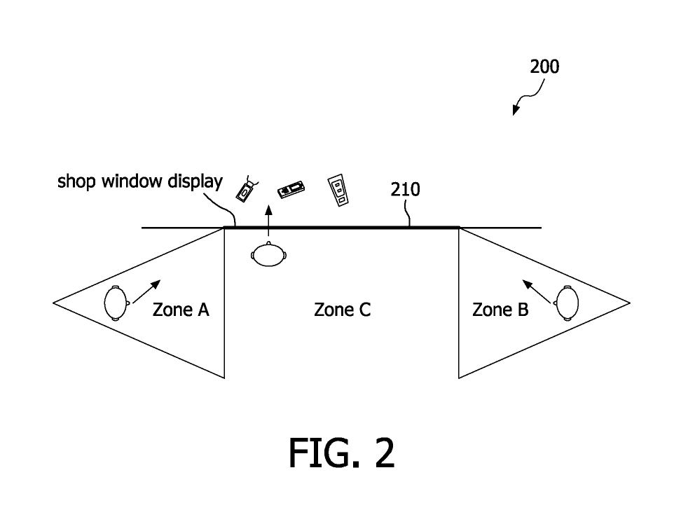

FIG. 2 shows an arrangement 200 configured as a shop window display 210 in accordance with embodiment of the present system. In accordance with the present system, the shop window 210 is operable to display information, such as an advertising related message, through use of blind elements arranged similar as discussed regarding FIG. 1. By providing an image through use of the blind elements, the message may be visible for viewers approaching the shop window as they walk along a shopping street and look at the shop window under a large viewing angle (e.g., greater than 10 degrees from normal). As may be readily appreciated, even transparent glass, when viewed from a large incident angle, is to an appreciable extent reflective, thereby rendering display presentations positioned within the shop windows, ineffective at those large incidence angles. However, in accordance with an embodiment of the present system, the blind elements in accordance with an embodiment of the present system, provides an “eye catcher” to attract attention from people passing by the shop window. Moreover, a shop window in accordance with the present system enables a display of anticipatory information visible from a relatively large distance and from a large viewing angle to potential shoppers approaching the shop window.

In conventional shop windows, a problem exists in that when an attempt is made to convey information that is intended to be visible from both, far away and close by, simultaneously, a clutter of information is provided. The present system provides a solution for the problem of information clutter in shop windows by providing a possibility to separate announcements from actual products and messages viewable through the shop window by making the announcements visible only when viewed from a particular angle, such as from an angle of 10 degrees or more from normal to a surface of the shop window display. In accordance with the present system, an electronic shop window is provided that is able to switch between two or more different display states, such as between an emissive state, when view from an angle of 10 degrees or more, and a transparent state when viewed from an angle less than 10 degrees.

In FIG. 2, three different viewing zones, zone A, zone B and zone C are shown wherein a different visual image may be provided in two or more of the zones. In accordance with the present system, the image provided for (potential) customers approaching the shop (zones A and B) may be provided independent of the image provided for people who are in front or are approaching from the front of the shop window (zone C), such as provided by items placed in an area of the shop window. This means that the advertising information provided may be different for relatively large viewing angles than for a near-normal viewing angle.

By a careful selection of a display image provided by the display elements 150 shown in FIG. 1, the display image may be viewable from a large angle of incidence (e.g., greater than 70 degrees) to a relatively small angle of incidence (e.g., less than 20 degrees). For example, in a case wherein the display image is provided as a written message, such as “SALE” as illustratively shown in FIG. 6, a distribution of the written message across the blind elements 120 may be selected to provide the written message in a more spread-out, but legible form at a higher angle of incidence and in a more compressed, but legible form at a lower angle of incidence. Similar considerations may be provided for enabling viewing of pictorial images throughout a range of viewing angles.

In one embodiment, each blind element may provide a single row (horizontal) pixel or some other relatively small number of pixels (e.g., 4 pixels) having a number of column (vertical) pixels provided along the vertical lengthwise span of the blind element. In this way, as long as the pixels of the blind element are visible, the image provided by the plurality of blind elements will be visible throughout a range of viewing angles.

In one embodiment in accordance with the present system, the blinds may be provided as electronic paper (e-paper) display surfaces, such as by having electrophoretic electronic Ink (as provided by e.g. the e-Ink Corporation) material being printed on one or more of the faces of the blinds (e.g., non-edge surfaces). In this embodiment, the blind faces covered with e-Ink may be switched, for example, between black and white reflective states. Electronic ink applications provide a tremendous advantage in that once an image is set in the e-Ink covered blinds, no further power is required to maintain the image unlike active display elements. A disadvantage of this embodiment is the need of an active matrix to set an image into the blinds. Further, traditional e-Ink displays have an inability to display color images.

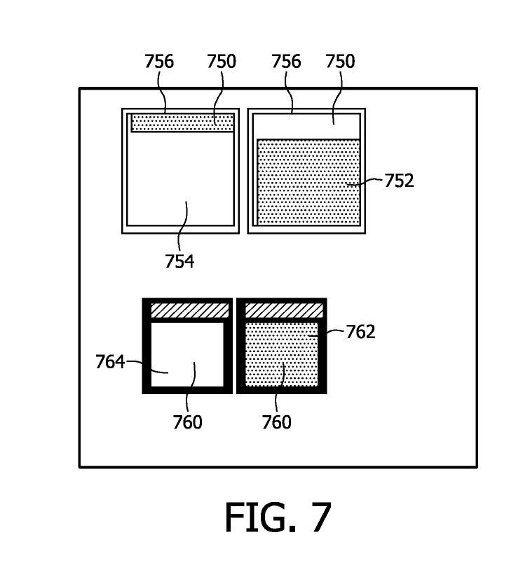

The blinds may be covered by electrophoretic cells, such as in-plane electrophoretic cells 750, 760 such as illustratively shown in FIG. 7. The electrophoretic cells 750, 760 may be driven by an active matrix or passive matrix as appreciated by a person of ordinary skill in the art. In accordance with an embodiment of the present system, the electrophoretic cells 750, 760 may be switched between corresponding colored states 752, 762 and transparent states 754, 764. For example, in one embodiment wherein the electrophoretic cells are configured having a colored state, a three-layer structure (e.g., red, green and blue or cyan, magenta and red electrophoretic layers), may be provided to enable a full color display. Naturally, less colored layers may be provided corresponding to less flexibility in the colored display of the electrophoretic cells. In another embodiment, the electrophoretic cells may be provided with color filters (e.g., one or more of red, green and blue filters) as readily appreciated to provide flexibility in the color presentation.

In yet another embodiment, the charged particles of the electrophoretic cells may be configured as scattering particles, thereby enabling the electrophoretic cells to switch between a reflective state and a transparent state. In a further embodiment, a reflector, such as a white reflector 756, may be provided behind the electrophoretic cells. In this way, the electrophoretic cells may be switched to a state wherein a display image is provided directly from the electrophoretic cells, or an image may be reflected from the reflector background 756 of the electrophoretic cells. In one embodiment, the reflector 756 itself may be an e-Ink type layer, or an in-plane electrophoretic layer switching between transparent and white (scattering) providing further flexibility in that in this embodiment, the blind elements and thereby, the display window may be enabled to switch between four different states, namely: 1. an emissive state provided by the colored, monochromatic, dichromatic, etc. electrophoretic cells, such as the colored states 752, 762; 2. a transparent (window) state provided by selecting the particles of the electrophoretic cells to be in a collected state, such as the transparent states 754, 764, wherein particles of the electrophoretic cells 750, 760 are collected in a reservoir area; 3. a white state, for example providing a projection surface for a projected image (discussed in some detail herein); and 4. a reflective state providing a reflective display surface.

In accordance with an embodiment of the present system utilizing in-plane electrophoretic cells, a thickness of the electrophoretic layer provided may be as thin as 10 um utilizing current electrophoretic technologies although other technologies known or developed may also be suitably applied with varying affects on a thickness of the layer provided. In an embodiment wherein the blinds are made from a plastic material, the blind elements including the electrophoretic cells may be as thin as 100 um or less, which results in a display window having a transmissive quality of 90% transmissive glass (in a normal viewing direction). In this embodiment, a spacing for the blinds may be about 1 mm or more. For a viewing angle of 70 degrees provided in either of zones A, B, this embodiment may result in blind elements that are approximately 370 um wide, which is wide enough for presentation of a row of a single pixel. In an embodiment wherein a distance of approximately 2.7 cm spacing is provided between the blind elements, the glass of a display window will be 93% transmissive at a 10 degree viewing angle (e.g., within either of zones A, B).

Similar to the e-Ink embodiment, the electrophoretic cells may be monochromatic when activated (e.g., white or black) or may be dichromatic (e.g., white and black) wherein two different colored charged particles are contained within the electrophoretic cells. The electrophoretic cells may be transmissive or reflective as readily appreciated although in a simplified configuration, the electrophoretic cells are reflective alleviating a need for backlighting of the electrophoretic cells.

In one embodiment in accordance with the present system, the blinds may be formed from a white or scattering material and/or the electrophoretic cells may be configured to have a scattering state as discussed above, to serve as a front or back projection screen. In such an embodiment, a projector 140 may be utilized to assist in image formation on a surface of the blind elements 120 and/or the electrophoretic cells. In this embodiment, display elements 150 which may be in any number of states (see discussion above) are also present on the blind elements 120 and the combination of the projector 140 and the display elements 150 may together be utilized to form display images viewable from an incident angle to the display surface 160.

In one embodiment in accordance with the present system, the blind elements 120 may be formed from a transparent material, such as a clear plastic material or any other suitable transparent material. In this embodiment, the display elements 150 may be formed or embedded into the transparent material by any suitable method to enable viewing of objects, through the blind elements 120 and the display window 110, to viewers from all perspectives when an image is not otherwise presented by the display elements 150. Naturally, when the display elements 150 are actuated to provide an image, the display elements 150 may be selectively activated (e.g., colored) to provide a pixilated image for a display function.

Furthermore, as shown in FIG. 2, the images may be provided independently for customers approaching the display window from zones A and B as well as for zone C. For example, the discussion above illustratively focused on providing images from the blind element, such as from a side of the blind element facing a viewer approaching from one of zones A and B, such as zone A. However, by providing similar display structures (e.g., blind surface material and display elements) on an opposite side of the blind element, such as from a side of the blind element facing a customer approaching from zone B, an image may be provided to the customer approaching from zone A that is unrelated to an image provided to the viewer approaching from zone B. Accordingly, the blind 130 shown in FIG. 1 should be construed in one embodiment as showing structure provided on each side of the blind 130. Further, zone C, independent of the images provided in either of zones A and B, may provide an image to a viewer approaching from zone C that is independent of the images provided to viewers in either of zones A and B. For example, while a viewer, such as a potential customer, approaching from zone A may be provided with a written message, such as “SALE”, a viewer approaching from zone B may be provided with a pictorial image, such as a picture of items presented for sale. Further, a viewer standing before the display window may have a clear view of items and/or signage provided in the display window area. Naturally, either of the images provided in zones A and B may alternate and/or change altogether and each of zones A, B and C may provide any combination of written and/or pictorial images.

In accordance with an embodiment of the present system, blind elements may be provided in blind element pairs, such as the “blind” elements 420, 430 depicted in FIG. 4. Each of the blind elements of a pair, such as blind elements 430A, 430C may be opposed to each other such that one of the pair is positioned for viewing from one direction while another one of the pair is positioned for viewing from an other direction. For example, the blind element 430A is positioned for viewing from a zone A, while the blind element 430C is mostly not viewable from the zone A. Conversely, the blind element 430C is positioned for viewing from a zone C, while the blind element 430A is mostly not viewable from the zone C. In this way, the viewing angle of the blind elements may be individually adjusted to provide an optimal viewing angle for a given intended application. Naturally, in this embodiment, the blind elements may be configured to only provide an image on one of the surfaces of each element of the element pairs with differentiation in the relative angle provided for each of zones A and C if desired. For example, blind element 430A may be angled at 45 degrees from normal to provide a view for passerby's of a window, such as window 410, at a relatively sharp angle of approach to zone A of the window to drawn the passerby's attention to the zone B when before the window 410. In the same embodiment, blind element 430C may be angled at greater than 45 degrees from normal to provide a view for a passerby coming towards the window 410 within zone C such as may be provided for a window positioned at a corner of a cross street wherein zone C is positioned on the corner.

In another embodiment, common row and column addressing and driving circuits may be provided for driving the display elements on each side of the blind elements to provide a same or similar image to customers approaching from either of zones A, B. In this embodiment, the row and column addressing and driving circuits may accordingly be deleted from one side of the blind while maintaining display elements on both sides of the blind. In yet another embodiment, while common row and column addressing and driving circuits may be provided, a separate memory or memory locations may be utilized for providing image storage that is independently addressable for driving the display elements on each side of the blind elements independently.

As may be readily appreciated, for viewing angles smaller than the ideal angle, a mixture between the display provided by the blind elements and objects positioned in an area of the display window is visible. In a typical display window, the objects in an area of the display window are positioned lower than the viewer. In other words, a viewer positioned within zone C, generally looks through the display window in a downward direction. The images provided by the blind elements in zones A and B, however, may be positioned to provide a substantially horizontal viewing direction to eliminate a distraction provided by simultaneously viewing the images provided by the blind elements and the image provided by objects positioned in an area of the display window. By painting the sidewalls and parts of the back wall of the area behind the display window (from a viewpoint of a viewer of the display window) in a monochrome color, the blinds may stand out more clearly which may tend to enhance the perception of the display provided. A darker monochrome color is more suitable to enhance the contrast, but some brands don't allow dark walls and/or sidewalls be utilized for those brands items.

In another embodiment, the display window may be covered with a coating, such as a coating 165 applied to an inner surface 162 of the display window 110 as shown in FIG. 1. The coating may enhance the reflective quality of the display window 110 when viewed from angles outside of zone C, thereby reducing a distraction presented by the objects positioned in an area of the display window and enhancing the images provided by the blind elements 120.

As may be readily appreciated, numerous types of display elements may be readily utilized in accordance with the present system. For example, the display elements may be electrophoretic cells as discussed above; may be other electronic paper-like display elements such as electrochromic elements, electrowetting elements, electrodeposition elements, MEMS elements (such as roll blinds or moving foil elements); may be light emitting diodes (LEDs), liquid crystal displays (LCDs), polymer dispersed liquid crystal displays (PDLC), Guest-host type liquid crystal displays; and/or any other display elements that may be suitably applied.

Returning to FIG. 3, another embodiment of the present system includes an embodiment wherein blind elements, including blind elements 320, 380, 390, 395 are associated with a surface of the window 310 and are angled with reference to one of the surfaces 312, 314 of the window 310. In accordance with this embodiment, the blind elements may be angled at an angle of 10 degrees or more from parallel with one of the surfaces 312, 314, yet not be embedded within either of the surfaces 312, 314. In this way, the blind elements my be positioned and formed as desired without restriction to manufacturing of the window 310. For example, the blind elements may be added to existing windows without the expense of replacing the entire window. Additionally, the window may be manufactured by typical window manufacturing processes without alteration in that the blind elements may be manufactured separately irrespective of the window manufacturing process. As in prior embodiments, the blind elements may be sized and positioned to suit a given application with variations in the angling of the blind elements to alter an appearance of an image presented by the blind elements in each of zones A, C and/or an angle in which the image may be viewed. In this embodiment, the blind elements may also be presented in blind element pairs as shown in FIG. 4, such as blind elements pairs 480, 490, without being embedded in the window. Operation of these blind elements and/or blind element pair is similar as described regarding embedded blind elements and accordingly, need not be described further.

A further layer 316 may be provided on a viewing side 315 (e.g., a position where a viewer is typically passing the window 310, such as within one of zones A, B, C as shown in FIG. 2) of the window 310 such that blind elements are sandwiched between the further layer 316 and the window 310. By the term sandwiched, it is intended that the blind elements may be embedded in one or more of the window and further layer(s) or may be simply positioned between the window and further layer(s). In another or further embodiment, a further layer 318 may be provided on a backside 317 of the window 310 sandwiching blind elements on the backside 317 of the window 310.

The further layers 316, 318 may be formed from any suitable relatively transparent material, such as a same or different material from the window 310, so as to not obstruct viewing of the window 310 or objects positioned behind the window (e.g., on the backside 317). For example, the further layers may be formed from glass, plastic, plastic composites, etc. as readily appreciated by a person of ordinary skill in the art. The further layer 318 is shown wherein blind elements may be embedded (e.g., partially embedded, fully embedded, etc.) in the further layer 318. Although not shown for purposes of simplifying the figures, the further layer 316 may be similarly positioned with regard to the blind elements and/or window 310. In one embodiment, the blind elements may be embedded in one or more of the further layers such that the further layer(s) may be added to a window without associated blind elements to provide the window with the present system. This embodiment may be provided as a retrofit to an existing window to add the present system without need to substantially alter the pre-existing window. For example, the blind elements may be formed with the further layer(s) and the further layer(s) may be positioned with regard to the pre-existing window to add the present system to the pre-existing window. In one embodiment, the further layer(s) and blind elements may be provided as a film that is laid over or positioned in close proximity to the pre-existing window or simply a window that by itself, does not have the present system. In an embodiment wherein the further layer(s) do not touch a surface of the window, an air gap may exist between the window and further layer(s). In a further embodiment, a fluid other than air may be provided between the window and further layer(s). The window (e.g., pre-existing, etc.) may embody the present system and a further layer with blind elements may be added to provide further images, angles, etc. to viewers of the window as an enhancement to a window that already provides the present system. The further layer(s) may only cover a portion of the window or may cover an entire surface of the window. For example, a portion of the window may be provided with one or more further layer(s) to provide a highlight of items positioned behind the window and/or to advertise a pending sale. In one embodiment, the blind elements may only be provided in a portion of the window and/or further layer(s). The further layers may be overlaid on each other to provide multiple layers of the present system on a given side of the window. For example, a first further layer may be provided with blind elements at a first given angle with reference to the first further layer and a second further layer may be provided with blind elements at a second given angle with reference to the second further layer. In one embodiment, an angle of blind elements with reference to the further layer may vary over the further layer as described above regarding the window to provide different angles of viewing images provided by the blind elements over the further layer. Naturally, the blind elements may be positioned in pairs as shown in FIG. 4.

The embodiments described above are intended for purposes of illustration only and should not be construed as limiting the appended claims to any particular embodiment or group of embodiments. So, as should be clear, numerous alternative embodiments may be devised by those having ordinary skill in the art without departing from the spirit and scope of the following claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

1. An article of manufacture (110, 210, 310, 410, 510) comprising a plurality of blind elements (120, 210, 320, 330, 340, 350, 360, 370, 380, 385, 390, 420, 430, 490) associated with the article of manufacture (110, 210, 310, 410, 510), wherein each of the plurality of blind elements (120, 210, 320, 330, 340, 350, 360, 370, 380, 385, 390, 420, 430, 490) comprise a plurality of electrophoretic cells (150, 750, 760) that are configured to provide the display image positioned at an angle offset from parallel to an article of manufacture surface to be viewable through the article of manufacture (110, 210, 310, 410, 510) such that if the article of manufacture (110, 210, 310, 410, 510) is viewed from an angle offset from a normal viewing angle, the plurality of electrophoretic cells (150, 750, 760) on each of the blind elements (120, 210, 320, 330, 340, 350, 360, 370, 380, 385, 390, 420, 430, 490) are together configured to provide a display image.

2. The article of manufacture (110, 210, 310, 410, 510) of claim 1, wherein the blind elements (120, 210, 320, 330, 340, 350, 360, 370, 380, 385, 390, 420, 430, 490) are embedded in a further layer (316, 318) associated with the article of manufacture (110, 210, 310, 410, 510).

3. The article of manufacture (110, 210, 310, 410, 510) of claim 2, wherein the further layer (316, 318) is overlaid on the article of manufacture (110, 210, 310, 410, 510).

4. The article of manufacture (110, 210, 310, 410, 510) of claim 2, wherein the further layer (316, 318) includes a plurality of further layers (316, 318).

5. The article of manufacture of (110, 210, 310, 410, 510) claim 2, wherein the further layer (316, 318) is positioned before a portion less than an entire surface of the article of manufacture (110, 210, 310, 410, 510).

6. The article of manufacture (110, 210, 310, 410, 510) of claim 2, wherein the further layer (316, 318) is provided as a film.

7. The article of manufacture (110, 210, 310, 410, 510) of claim 1, wherein the blind elements (120, 210, 320, 330, 340, 350, 360, 370, 380, 385, 390, 420, 430, 490) are sandwiched between a further layer (316, 318) and the article of manufacture (110, 210, 310, 410, 510).

8. The article of manufacture (110, 210, 310, 410, 510) of claim 1, wherein the blind elements (120, 210, 320, 330, 340, 350, 360, 370, 380, 385, 390, 420, 430, 490) are at least partially embedded in the article of manufacture (110, 210, 310, 410, 510).

9. The article of manufacture (110, 210, 310, 410, 510) of claim 8, wherein the blind elements (120, 210, 320, 330, 340, 350, 360, 370, 380, 385, 390, 420, 430, 490) are at least partially embedded in the article of manufacture (110, 210, 310, 410, 510) substantially perpendicular to a surface of the article of manufacture (110, 210, 310, 410, 510).

10. The article of manufacture (110, 210, 310, 410, 510) of claim 1, wherein the plurality of electrophoretic cells (150, 750, 760) comprise light scattering charged particles and wherein the plurality of electrophoretic cells (150, 750, 760) are configured to present the light scattering charged particles as a portion of the display image.

11. The article of manufacture (110, 210, 310, 410, 510) of claim 1, wherein the plurality of electrophoretic cells (750) each comprise a reflective surface (756) deposed around each of the plurality of electrophoretic cells (750), wherein the reflective surfaces (756) are configured to provide a reflected image as a portion of the display image.

12. The article of manufacture (110, 210, 310, 410, 510) of claim 1, wherein the display surface (135) of each of the plurality of blind elements (420, 430, 490) is one of two display surfaces of each of the plurality of blind elements (420, 430, 490), with each of the two display surfaces (135) being configured on oppositely opposing sides of each of the plurality of blind elements (420, 430, 490) and being configured to each produce a display image.

13. The article of manufacture of claim 1, wherein the plurality of electrophoretic cells (150) comprise electronic ink display elements that are configured to provide the display image.

14. The article of manufacture of claim 1, wherein the blind elements (120, 210, 320, 330, 340, 350, 360, 370, 380, 385, 390, 420, 430, 490) are configured to provide at least two of an emissive display state, a transparent state, a white state and a reflective state.

15. A method of providing an advertising image, the method comprising acts of:
providing a plurality of blind elements associated with a window, wherein each of the plurality of blind elements comprise a plurality of display elements positioned to be viewable through the window:
producing the advertising image by the plurality of display elements such that the advertising message is viewable from an angle offset from a normal viewing angle.

16. The method of claim 15, wherein the advertising image is a first advertising message, the method comprising an act of producing a second advertising image by the plurality of display elements such that the second advertising message is viewable from an angle offset from a normal viewing angle and is positioned on an opposing side of the plurality of blind elements as the first advertising message.

17. The method of claim 15, wherein the act of providing the plurality of blind elements associated with the window comprises an act of embedding the plurality of blind elements in the window substantially perpendicular to a surface of the window.
